(19) United States
(12) Patent Application Publication
(10) Pub. No.: US 2004/0002273 A1
(43) Pub. Date: Jan. 1, 2004

(54) Liquid repellent nonwoven protective material

(75) Inventors: Steven Wayne Fitting, Acworth, GA (US); Michael David Powers, Canton, GA (US)

Correspondence Address: KIMBERLY-CLARK WORLDWIDE, INC., 401 NORTH LAKE STREET, NEENAH, WI, 54956

(73) Assignee: Kimberly-Clark Worldwide, Inc.

(21) Appl. No.: 10/188,395

(22) Filed: Jul. 1, 2002

(51) Int. Cl. D04H 1/00; B32B 5/26

(52) U.S. Cl. 442/351; 442/80; 442/81; 442/340; 442/381; 442/401; 442/409; 156/290; 156/291

(57) ABSTRACT

The present invention provides a liquid repellent nonwoven protective material comprising a meltspun microfiber layer and one or more additional nonwoven layers bonded to the meltspun microfiber layer. The meltspun microfiber layer comprises a high melt flow rate olefin polymer (i.e., having a melt flow rate of at least 1500 grams per 10 minutes as measured by ASTM-D-1238-01 at 177° C.), a melt flow modifying agent and a liquid repellency internal additive. The high melt flow rate olefin polymer is substantially prodegradant-free and is present in amounts from about 78 percent by weight to about 94.9 percent by weight. The liquid repellency internal additive, such as a fluorochemical or fluoropolymer, is present in amounts from about 0.1 percent by weight to about 2 percent by weight, and the melt flow modifying agent, such as polymers and copolymers of butene, is present in amounts from about 5 percent by weight to about 20 percent by weight. The invention provides protective fabrics and garments such as medical products such as surgical drapes and gowns, and protective workwear garments from the liquid repellent nonwoven protective material. The invention additionally provides a process for making the nonwoven protective material.

### TECHNICAL FIELD

The present invention is related to a nonwoven laminate material having repellency to low surface tension liquids including alcohols, aldehydes and ketones.

### BACKGROUND OF THE INVENTION

Many of the personal care products, mortuary and veterinary products, protective wear garments, and medical care garments and products in use today are partially or wholly constructed of nonwoven materials. Examples of such products include, but are not limited to, medical and health care products such as surgical drapes, gowns and bandages, protective workwear garments such as coveralls and lab coats, and infant, child and adult personal care absorbent products such as diapers, training pants, disposable swimwear, incontinence garments and pads, sanitary napkins, wipes and the like. For these applications nonwoven fibrous webs provide tactile, comfort and aesthetic properties which can approach or even exceed those of traditional woven or knitted cloth materials. Other nonwoven material properties may be desirable depending on end-use applications. For example, some applications such as liners for diapers and feminine hygiene products call for nonwovens which are highly wettable and will quickly allow liquids to pass through them. On the other hand, for applications such as protective fabrics, for instance medical products such as surgical fabrics for drapes and gowns, and fabrics for other protective garments, barrier properties are highly desirable. Further, surgical fabrics for drapes and gowns should have a high degree of repellency to low surface tension liquids such as alcohols, aldehydes, ketones and hydrophilic liquids, such as those containing surfactants, in order to more fully protect medical personnel. Repellency to low surface tension liquids is also highly desirable for protective garment fabrics such as lab coats or industrial protective workwear, for example.

In a nonwoven laminate material such as a spunbond-meltblown-spunbond or “SMS” laminate, a meltspun microfiber layer (the meltblown layer in a SMS laminate) provides breathable barrier properties. That is, the microfibers of the meltblown layer form a structure having a small average pore size able to inhibit passage of liquids and particles alike while at the same time allowing gases such as air and water vapor to pass. Generally speaking, the finer the fibers are in the microfiber layer the smaller the average pore size will be, which results in better barrier. Two important polymer characteristics for production of fine extruded fibers such as meltspun microfibers are having a high melt flow rate (or “MFR”) and a narrow molecular weight distribution (or “Mw/Mn”).

For polymers such as the Ziegler-Natta catalyzed propylene polymers conventionally used to make meltspun microfiber web layers like meltblown webs, the melt flow rates are generally less than about 1000 grams per 10 minutes and the molecular weight distribution is in the range of 4 to 4.5. U.S. Pat. No. 4,451,589 to Morman et al. discloses polymer pellets having a prodegradant such as peroxide to partially degrade the polymer, increasing its melt flow rate and decreasing or narrowing its molecular weight distribution, and finer fiber nonwoven webs with improved barrier properties have been disclosed in U.S. Pat. No. 5,213,881 to Timmons et al. In U.S. Pat. No. 5,213,881 peroxides were added to propylene polymer polymerized with a Ziegler-Natta catalyst in order to significantly increase the melt flow rate of the extruded polymer (or “MFR”) to as high as 3000 grams per 10 minutes and to narrow the molecular weight distribution of the extruded polymer to as low as 2.2 to 3.5, thereby reducing the average fiber size to 1 to 3 microns and reducing the average pore size to 7 to 12 microns with the peak of the pore size distribution being less than 10 microns.

As mentioned above, it is also very desirable for protective fabrics such as surgical gowns and drapes and other protective garments to have, in addition to breathable barrier properties, a high degree of repellency to liquids such as water and low surface tension liquids such as alcohols, aldehydes, ketones and hydrophilic liquids such as those containing surfactants. Means for providing liquid repellent properties to nonwoven webs are known in the art, such as by incorporating a fluorocarbon liquid repellency additive as an internal additive in the polymer melt prior to extruding the fibers.

Therefore, in order to provide nonwoven webs from conventionally produced polymers (such as those made using a Ziegler-Natta catalyst) having the best protective properties, it was necessary to use fluorocarbon compounds for liquid repellency in conjunction with peroxide degradation of the polymer to increase melt flow rate and decrease or narrow the molecular weight distribution. However, while the peroxide prodegradants provide desirable degradation of the extruded polymer, they also degrade the internal additive fluorocarbon compounds to a certain degree, which is not desirable. Degradation of fluorocarbon compounds is expensive in terms of additive raw material cost, since more of the additive must be used to achieve the same repellent effect than in the case where the fluorocarbon compounds are not degraded. Also, degradation of the fluorocarbon compounds may make them more susceptible to volatilization during the melting and extruding process, creating the potential for vapor inhalation hazards in exposed individuals.

Consequently, there remains a need for a nonwoven laminate protective fabric having high barrier properties and having high liquid repellency which is economical and the production of which results in less risk of volatilization of the liquid repellent internal additive compounds.

### SUMMARY OF THE INVENTION

The present invention provides a liquid repellent nonwoven laminate material useful in medical products and other protective garments comprising a meltspun microfiber layer having an average microfiber diameter of less than about 10 microns and one or more additional nonwoven layers bonded to the meltspun microfiber layer. The meltspun microfiber layer comprises a non-chemically degraded high melt flow rate olefin polymer (i.e., having a melt flow rate of at least 1500 grams per 10 minutes) which is substantially free of prodegradants, a low surface tension liquid repellency internal additive and a melt flow modifying agent. The meltspun microfiber layer may be a meltblown microfiber layer, and the additional nonwoven layer or layers may be monocomponent or bicomponent spunbond nonwoven layers In some embodiments, the meltspun microfiber layer may have microfibers of average diameter less than about 7 microns, and in other embodiments the meltspun microfiber layer may have microfibers of average diameter less than about 5 microns.

In certain embodiments, the meltspun microfiber layer comprises a non-chemically degraded, high melt flow rate, substantially prodegradant-free olefin polymer in amounts ranging from about 78 percent by weight to about 94.9 percent by weight, a liquid repellency internal additive in amounts ranging from about 0.1 percent by weight to about 2 percent by weight, and a melt flow modifying agent in amounts from about 5 percent by weight to about 20 percent by weight.

The additional nonwoven layer or layers may be bonded to the meltspun microfiber layer by thermal, adhesive, or ultrasonic bonding or by other means known in the art. The repellent nonwoven laminate may comprise a single additional nonwoven layer bonded to the meltspun microfiber layer, or may comprise additional nonwoven layers bonded to both sides of the meltspun microfiber layer. The additional nonwoven layer or layers may further comprise from about 0.1 weight percent to about 2 weight percent of a low surface tension liquid repellency internal additive. The additional nonwoven layer or layers may also comprise other ingredients or treatments such as an antistatic treatment.

The invention provides protective fabrics and garments such as medical products such as surgical drapes and gowns, and protective workwear garments from the liquid repellent nonwoven laminate material. The invention additionally provides a process for making the nonwoven laminate material.

### BRIEF DESCRIPTION OF THE DRAWINGS

FIG. 1 is a schematic illustration of an embodiment of the nonwoven protective material of the present invention.

FIG. 2 is a schematic illustration of another embodiment of the nonwoven protective material of the present invention.

FIG. 3 is a partially cut-away perspective view of the embodiment of the nonwoven protective material shown in FIG. 2.

FIG. 4 is a schematic illustration of various medical products fabricated with the nonwoven protective material of the present invention.

### DETAILED DESCRIPTION OF THE INVENTION

### DEFINITIONS

As used herein and in the claims, the term “comprising” is inclusive or open-ended and does not exclude additional unrecited elements, compositional components, or method steps.

As used herein the term “polymer” generally includes but is not limited to, homopolymers, copolymers, such as for example, block, graft, random and alternating copolymers, terpolymers, etc. and blends and modifications thereof. Furthermore, unless otherwise specifically limited, the term “polymer” shall include all possible geometrical configurations of the material. These configurations include, but are not limited to isotactic, syndiotactic and random symmetries.

As used herein the term “prodegradant” refers to compounds such as, for example, peroxides which decompose forming free radicals which may be added to a polymer to degrade the polymer, increasing the melt flow rate and/or decreasing or narrowing the molecular weight distribution. Peroxide addition to polymer pellets is described in U.S. Pat. No. 4,451,589 to Morman et al.

As used herein the term “fibers” refers to both staple length fibers and substantially continuous filaments, unless otherwise indicated. As used herein the term “substantially continuous” filament means a filament or fiber having a length much greater than its diameter, for example having a length to diameter ratio in excess of about 15,000 to 1, and desirably in excess of 50,000 to 1.

As used herein the term “monocomponent” fiber refers to a fiber formed from one or more extruders using only one polymer. This is not meant to exclude fibers formed from one polymer to which small amounts of additives have been added for color, anti-static properties, lubrication, hydrophilicity, liquid repellency, etc. These additives, e.g. titanium dioxide for color, are conventionally present, if at all, in an amount less than 5 weight percent and more typically about 1-2 weight percent.

As used herein the term “multicomponent fiber” refers to a fiber formed from at least two component polymers, or the same polymer with different properties or additives, extruded from separate extruders but spun together to form one fiber. Multicomponent fibers are also sometimes referred to as conjugate fibers or bicomponent fibers, although more than two components may be used. The polymers are arranged in substantially constantly positioned distinct zones across the cross-section of the multicomponent fibers and extend continuously along the length of the multicomponent fibers. The configuration or arrangements of components in such a multicomponent fiber may be, for example, sheath/core, side by side, “islands-in-the-sea”, pie-wedges or stripes on a round, oval or rectangular cross-section fiber, or other. Multicomponent fibers are taught in U.S. Pat. No. 5,108,820 to Kaneko et al., U.S. Pat. No. 5,336,552 to Strack et al., and U.S. Pat. No. 5,382,400 to Pike et al.

As used herein the term “biconstituent fiber” or “multiconstituent fiber” refers to a fiber formed from at least two polymers, or the same polymer with different properties or additives, extruded from the same extruder as a blend and wherein the polymers are not arranged in substantially constantly positioned distinct zones across the cross-section of the multicomponent fibers. Fibers of this general type are discussed in, for example, U.S. Pat. No. 5,108,827 to Gessner.

As used herein the term “nonwoven web” or “nonwoven fabric” means a web having a structure of individual fibers or filaments which are interlaid, but not in an identifiable manner as in a knitted or woven fabric. Nonwoven fabrics or webs have been formed from many processes such as for example, meltblowing processes, spunbonding processes, and carded web processes. The basis weight of nonwoven fabrics is usually expressed in mass per unit area as in grams of material per square meter (gsm) or ounces of material per square yard (osy) and the fiber diameters useful are usually expressed in microns. (Note that to convert from osy to gsm, multiply osy by 33.91).

As used herein the term “spunbond” refers to a nonwoven fiber fabric of small diameter filaments that are formed by extruding molten thermoplastic polymer as filaments from a plurality of capillaries of a spinneret. The extruded filaments are cooled while being drawn by an eductive or other well known drawing mechanism. The drawn filaments are deposited or laid onto a forming surface in a generally random, isotropic manner to form a loosely entangled fiber web, and then the laid fiber web is subjected to a bonding process to impart physical integrity and dimensional stability. The production of spunbond fabrics is disclosed, for example, in U.S. Pat. Nos. 4,340,563 to Appel et al., 3,802,817 to Matsuki et al. and 3,692,618 to Dorschner et al. Typically, spunbond fibers have a weight-per-unit-length in excess of 2 denier and up to about 6 denier or higher, although finer spunbond fibers can be produced.

As used herein the term “meltspun microfibers” means fibers formed by extruding a molten thermoplastic material through a plurality of fine, usually circular, die capillaries as molten threads or filaments. Meltspun microfibers are generally are smaller than 10 microns in average diameter. Desirably, meltspun microfibers are smaller than about 7 microns in average diameter, and more desirably smaller than about 5 microns in average diameter. A specific example of meltspun microfibers are those which may be made by the meltblowing process, wherein the molten threads or filaments are extruded through a plurality of fine die capillaries into converging high velocity gas (e.g. air) streams which attenuate the filaments of molten thermoplastic material to reduce their diameter. Thereafter, the meltblown fibers are carried by the high velocity gas stream and are deposited on a collecting surface to form a web of randomly dispersed meltblown fibers. Such a process is disclosed, for example, in U.S. Pat. No. 3,849,241 to Buntin. Meltblown fibers may be continuous or discontinuous, are generally smaller than 10 microns in diameter, and are generally tacky when deposited onto a collecting surface.

As used herein, “thermal point bonding” involves passing a fabric or web of fibers or other sheet layer material to be bonded between a heated calender roll and an anvil roll. The calender roll is usually, though not always, patterned in some way so that the entire fabric is not bonded across its entire surface. As a result, various patterns for calender rolls have been developed for functional as well as aesthetic reasons. Typically, the percent bonding area varies from around 10% to around 30% of the area of the fabric laminate web.

As used herein, the term “garment” means any type of apparel which may be worn, including industrial workwear and coveralls, undergarments, pants, shirts, jackets, gloves, socks, and the like.

As used herein, the term “medical product” or “medical and health care product” means surgical gowns and drapes, face masks, head coverings or surgical caps, shoe coverings, wound dressings, bandages, sterilization wraps, wipers and the like.

As used herein, the term “personal care product” means diapers, training pants, swim pants, absorbent underpants, adult incontinence products, and feminine hygeine products and the like.

The present invention provides a liquid repellent nonwoven laminate material comprising one or more meltspun microfiber layers and one or more additional nonwoven layers bonded to the meltspun microfiber layer, wherein the meltspun microfiber layer comprises high melt flow rate (i.e., greater than 1500 grams per 10 minutes) olefin polymer which is substantially prodegradant-free, a melt flow modifying agent and a liquid repellency internal additive. The invention additionally provides a process for making the nonwoven laminate material and provides protective fabrics and garments such as surgical drapes and gowns and protective workwear garments from the liquid repellent nonwoven laminate material. Exemplary ranges for the components of the meltspun microfiber layer are from about 78 percent by weight to about 94.9 percent by weight of the high melt flow rate olefin polymer, from about 5 weight percent to about 20 weight percent of the melt flow modifying agent, and from about 0.1 weight percent to about 2 weight percent of the liquid repellency internal additive.

The nonwoven laminate material of the invention comprises a meltspun microfiber layer and one or more additional nonwoven layers bonded thereto such as embodied in the bi-layer laminate material shown in FIG. 1. As shown in FIG. 1, the bi-layer embodiment of the nonwoven protective material is generally designated 10 and comprises meltspun microfiber layer 16 and additional nonwoven layer 14. Meltspun microfiber layer 16 may be for example a meltblown layer. The meltblowing process is well known in the art and will not be described in detail herein. Briefly, meltblowing involves extruding molten thermoplastic polymer through fine die capillaries as molten filaments. The molten filaments are extruded into converging streams of high velocity gas such as heated air streams to attenuate or draw down the filaments to a smaller diameter. The attenuated filaments are generally deposited on a collecting surface such as a foraminous forming belt or conveyor as a web in a random arrangement of filaments. Meltblowing is described, for example, in U.S. Pat. No. 3,849,241 to Buntin, U.S. Pat. No. 4,307,143 to Meitner et al., and U.S. Pat. No. 4,707,398 to Wisneski et al., all herein incorporated by reference. The meltspun microfibers should be smaller than about 10 microns in average diameter, and desirably are smaller than about 7 microns in average diameter, and more desirably smaller than about 5 microns in average diameter. Additionally, the meltspun microfiber layer may comprise multicomponent microfibers as are known in the art such as bicomponent meltblown fibers.

The nonwoven laminate material of the invention further comprises one or more additional layers bonded to the meltspun microfiber layer as a multilayer laminate material. Such laminate material may be made by processes as are known in the art such as for example by providing together to a melt spinning apparatus a substantially prodegradant-free olefin polymer having a melt flow rate of at least 1500 grams per 10 minutes, a liquid repellency internal additive and a melt flow modifying agent, and then extruding meltspun microfibers from the melt spinning apparatus to form a meltspun microfiber web, and then providing at least one additional nonwoven web layer and bonding the additional nonwoven web layer or layers to the meltspun microfiber web. Desirably, the additional layer or layers may be one or more spunbond nonwoven web layers.

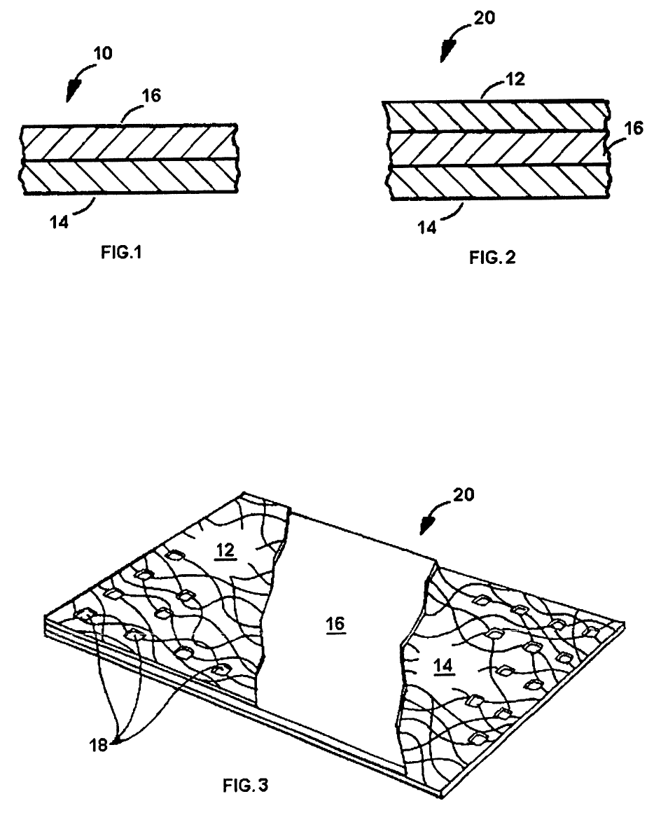

An example of a multilayer laminate material comprising one or more meltspun microfiber web layers and spunbond web layers is an embodiment such as a spunbond/meltblown/spunbond (SMS) laminate as disclosed in U.S. Pat. No. 4,041,203 to Brock et al., U.S. Pat. No. 5,169,706 to Collier, et al. and U.S. Pat. No. 4,374,888 to Bornslaeger, all herein incorporated by reference. Such a SMS laminate may be made by sequentially depositing onto a moving forming belt first a spunbond nonwoven web layer, then one or more meltblown web layers and last another spunbond layer and then bonding the laminate together by thermal point bonding, adhesive bonding or ultrasonic bonding or by other means as known in the art. Alternatively, one or more of the component nonwoven web layers may be made individually, collected in rolls, and combined together into a laminate material in a separate bonding step. Such a multilayer laminate is demonstrated as a 3-layer laminate, generally designated 20, in side-view in FIG. 2 and as a partially cut-away view in FIG. 3. With reference to FIGS. 2 and 3, meltspun microfiber layer 16 is shown sandwiched between additional nonwoven web layers 12 and 14. Additionally shown in FIG. 3 are exemplary bond points 18 such as may be made by a thermal point bonding process. As other alternatives, the multilayer laminate may be formed as a bilayer laminate such as for example a spunbond/meltblown laminate or SM laminate wherein one rather than both sides of the meltspun microfiber web layer has a spunbond layer bonded thereto, or the multilayer laminate may comprise multiple layers of meltspun microfiber web layers such as for example in a SMMS or SMMMS laminate material. Generally, such laminate materials have a basis weight of from about 0.1 osy to 12 osy (about 3 to about 400 gsm), or more particularly from about 0.5 osy to about 3 osy.

As stated above, the olefin polymer useful for the microfiber layer will have a high melt flow rate, desirably a melt flow rate of 1500 grams per 10 min or greater. Melt flow rate is a measure of the viscosity of the polymer expressed as the mass of material flowing from a capillary of known dimensions under a specified load or shear rate during a measured period of time. For example, the melt flow rate of high melt flow propylene polymers may be determined by measuring the mass of molten thermoplastic polymer under a 2.060 kg load that flows through an orifice diameter of 2.0995+/−0.0051 mm during a specified time period such as, for example, 10 minutes at the specified temperature such as, for example, 177° C. as determined in accordance with test ASTMD-1238-01, “Standard Test Method for Flow Rates of Thermoplastic By Extrusion Plastometer,” using a Model VE 4-78 Extrusion Plastometer available from Tinius Olsen Testing Machine Co., Willow Grove, Pa.

Generally speaking, production of finer fiber microfiber layers having smaller average pore size, and thus better barrier properties, is facilitated by using higher melt flow polymer. However, the olefin polymer must also be substantially free of prodegradants such as peroxides, so that other additives to the microfiber layer, especially the liquid repellency internal additive, are not unduly chemically degraded during the melting and extruding process. By “substantially free” what is meant is that for the raw high melt flow olefin polymer concentrations of prodegradants such as peroxides are desirably less than about 200 parts per million (“ppm”), more desirably less than about 75 ppm, and still more desirably less than about 25 ppm. Therefore, the high melt flow olefin polymer will not undergo chemical degradation during the melt processing into meltspun fibers.

Previously as was known in the art, high melt flow propylene polymers useful for producing microfiber layers (polymers having melt flow rates in excess of about 1000) were provided by adding a prodegradant such as a peroxide to conventionally produced polymers such as those made by Ziegler-Natta catalysts in order to partially degrade the polymer to increase the melt flow rate and/or narrow the molecular weight distribution. Peroxide addition to polymer pellets is described in U.S. Pat. No. 4,451,589 to Morman et al. and improved barrier microfiber nonwoven webs which incorporate peroxides in the polymer are disclosed in U.S. Pat. No. 5,213,881 to Timmons et al.

More recently, high melt flow rate polymers have become available which have high melt flow rates as-produced, that is, without the need of adding prodegradants such as peroxides to degrade the polymer to decrease viscosity/increase melt flow rate. Thus, these high melt flow rate polymers are able to produce webs of fine microfibers having small average pore size and good barrier properties without the use of prodegradants. Suitable high melt flow rate polymers can comprise polymers having a narrow molecular weight distribution and/or low polydispersity (relative to conventional olefin polymers such as those made by Ziegler-Natta catalysts) and include those catalyzed by “metallocene catalysts”, “single-site catalysts”, “constrained geometry catalysts” and/or other like catalysts. Examples of such catalysts and/or olefin polymers made therefrom are described in, by way of example only, U.S. Pat. No. 5,153,157 to Canich, U.S. Pat. No. 5,064,802 to Stevens et al., U.S. Pat. No. 5,374,696 to Rosen et al., U.S. Pat. No. 5,451,450 to Elderly et al., U.S. Pat. No. 5,204,429 to Kaminsky et al., U.S. Pat. No. 5,539,124 to Etherton et al., U.S. Pat. Nos. 5,278,272 and 5,272,236, both to Lai et al., U.S. Pat. No. 5,554,775 to Krishnamurti et al. and U.S. Pat. No. 5,539,124 to Etherton et al. Exemplary polymers having a high melt flow rate, narrow molecular weight distribution and low polydispersity are disclosed in U.S. Pat. No. 5,736,465 to Stahl et al. and are available from Exxon Chemical Company under the trade name ACHIEVE.

As has been stated, it is important that the laminate material be repellent to low surface tension liquids such as for example alcohols, aldehydes, ketones and hydrophilic liquid such as those containing surfactants. For this reason, the meltspun microfiber layer further comprises a low surface tension liquid repellency internal additive. Exemplary liquid repellency additives are fluorocarbon compounds which may be added to the polymer melt and which impart repellency to low surface tension liquids, such as alcohols, aldehydes, ketones and surfactant-containing liquids, to the meltspun microfibers and to the meltspun microfiber web layer itself. Desirably, the liquid repellency internal additive is present in an amount from about 0.1 weight percent to about 2 weight percent, and more desirably in an amount from about 0.25 to about 1.0 weight percent. As an example, the fluorocarbon compounds disclosed in U.S. Pat. No. 5,149,576 to Potts et al., herein incorporated by reference, and in U.S. Pat. No. 5,178,931 to Perkins et al., herein incorporated by reference, are well suited to providing liquid repellency properties to nonwoven fabrics. As stated above, the meltspun microfiber layer may desirably comprise multicomponent microfibers such as bicomponent or multicomponent meltblown microfibers. In this regard, it may be possible to reduce the amount of internal additive required by either using the additive in less than all of the components, or by using the additive in all components but using decreased concentrations in one or more of the components. Exemplary multicomponent fibers are disclosed in PCT Publication No. WO 02/09491 entitled “Fabrics Having Modified Surface Properties” which published Feb. 7, 2002 and which is herein incorporated by reference.

The liquid repellency internal additive will desirably migrate to the surface of the microfibers so that more of the additive will be available to provide repellent properties. To assist in this migration, the microfiber layer also comprises a melt flow modifying agent. The melt flow modifying agent is desirably present in an amount from about 5 weight percent to about 20 weight percent. The melt flow modifying agent should be of very high melt flow rate, desirably 3000 grams per 10 minutes or greater, and be capable of being co-spun with the polyolefin major component polymer of the microfiber layer. While not wishing to be bound by theory, we believe addition of a melt flow modifier acts to modify or increase the overall melt flow rate of the thermoplastic melt from which the microfibers are spun, and also acts as an agent to slow the crystallization rate of the polymer in the microfibers. With a slower crystallization rate more of the liquid repellency internal additive is able to migrate to the surface of the microfibers and in a more rapid fashion, thus giving the laminate material liquid repellent properties more quickly. Exemplary melt flow modifying agents are the polymers and copolymers of butene. A particularly useful melt flow modifying agent is an ethylene copolymer of 1-butene having about 5% ethylene and is available from Basell, USA, Inc. of Wilmington, Del. under the trade designation DP-8911. This ethylene copolymer of butene has a melt flow rate of approximately 3000 grams per 10 minutes as measured by ASTM-D-1238-01 at 177° C.

The liquid repellent laminate material of the invention comprises, in addition to the meltspun microfiber web layer, one or more additional nonwoven layers bonded to the meltspun microfiber layer. Suitable additional layers include nonwoven layers made by the spunbonding process. As an example, the liquid repellent laminate may be a spunbond/meltblown (SM) laminate or a spunbond/meltblown/spunbond (SMS) laminate. Processes for the formation of spunbond fibers and spunbond nonwoven webs are well known in the art and will not be described in detail herein. Briefly, spunbond webs are formed by extruding molten thermoplastic polymer as filaments from a plurality of capillaries of a spinneret. The extruded filaments are cooled or “quenched” while being drawn by an eductive gun or pneumatic slot draw unit or other well known drawing mechanism. The drawn filaments are deposited or laid onto a foraminous forming surface in a generally random, isotropic manner to form a loosely entangled fiber web, and then the laid fiber web is subjected to a bonding process to impart physical integrity and dimensional stability. The production of spunbond fabrics is disclosed, for example, in U.S. Pat. No. 4,340,563 to Appel et al., U.S. Pat. No. 3,802,817 to Matsuki et al. and U.S. Pat. No. 3,692,618 to Dorschner et al., all herein incorporated by reference. Typically, spunbond fibers have a weight-per-unit-length in excess of 2 denier and up to about 6 denier or higher, although finer spunbond fibers are known and can be produced. In addition, processes for the formation of SM or SMS laminates are disclosed in disclosed in U.S. Pat. No. 4,041,203 to Brock et al., U.S. Pat. No. 5,169,706 to Collier, et al. and U.S. Pat. No. 4,374,888 to Bornslaeger, all herein incorporated by reference.

Polymers suitable for the additional nonwoven web layers include polyolefins, polyesters, polyamides, polycarbonates and copolymers and blends thereof. Suitable polyolefins include polypropylene, e.g., isotactic polypropylene, syndiotactic polypropylene, blends of isotactic polypropylene and atactic polypropylene; polyethylene, e.g., high density polyethylene, medium density polyethylene, low density polyethylene and linear low density polyethylene; polybutylene, e.g., poly(1-butene) and poly(2-butene); polypentene, e.g., poly(1-pentene) and poly(2-pentene); poly(3-methyl-1-pentene); poly(4-methyl-1-pentene); and copolymers and blends thereof. Suitable copolymers include random and block copolymers prepared from two or more different unsaturated olefin monomers, such as ethylene/propylene and ethylene/butylene copolymers. Suitable polyamides include nylon 6, nylon 6/6, nylon 4/6, nylon 11, nylon 12, nylon 6/10, nylon 6/12, nylon 12/12, copolymers of caprolactam and alkylene oxide diamine, and the like, as well as blends and copolymers thereof. Suitable polyesters include polyethylene terephthalate, poly-butylene terephthalate, polytetramethylene terephthalate, polycyclohexylene-1,4-dimethylene terephthalate, and isophthalate copolymers thereof, as well as blends thereof. Selection of polymers for the fibers of the additional nonwoven layers is guided by end-use need, economics, and processability. The list of suitable polymers herein is not exhaustive and other polymers known to one of ordinary skill in the art may be employed.

The fibers of the additional nonwoven web layers may be monocomponent fibers or multicomponent fibers, and may be uncrimped or crimped. Crimped multicomponent fibers are highly useful for producing bulky or lofty nonwoven fabrics and may desirably be used for applications where cloth-like aesthetics such as softness, drapability and hand are of importance. As an example, where the liquid repellent nonwoven laminate material is a SMS material used for surgical gowns, one or more of the spunbond layers and particularly the body-side spunbond layer (the layer worn closest to the wearer) may be a crimped multicomponent spunbond layer to impart added in-use comfort to the gown material. Multicomponent fiber production processes are known in the art. For example, U.S. Pat. No. 5,382,400 to Pike et al., herein incorporated by reference, discloses a suitable process for producing multicomponent fibers and webs thereof.

In certain embodiments, it may be important for the nonwoven laminate material to have additional repellency. In these embodiments it may be desirable for one or more of the additional nonwoven layers to incorporate as an internal additive a liquid repellency additive. For example, where the nonwoven laminate material is a SMS laminate used in a surgical gown, it may be desirable for one of the spunbond nonwoven layers, for example the spunbond layer to be worn on the outer layer away from the wearer's skin, to incorporate a liquid repellency internal additive.

Various additional finishes, additives, and/or potential processing steps known in the art such as aperturing, slitting, stretching, treating, or further lamination with films or other nonwoven layers, may be performed on the nonwoven laminate material of the invention without departing from the spirit and scope of the invention. An example of a web finishing treatment is electret treatment to induce a permanent electrostatic charge in the web. In addition, treatment to provide antistatic properties to the nonwoven laminate material may be highly desirable. Antistatic treatments may be applied topically by spraying, dipping, etc., and an exemplary topical antistatic treatment is a 50% solution of potassium N-butyl phosphate available from the Stepan Company of Northfield, Ill. under the trade name ZELEC. Another exemplary topical antistatic treatment is a 50% solution of potassium isobutyl phosphate available from Manufacturer's Chemical, LP, of Cleveland, Tenn. under the trade name QUADRASTAT.

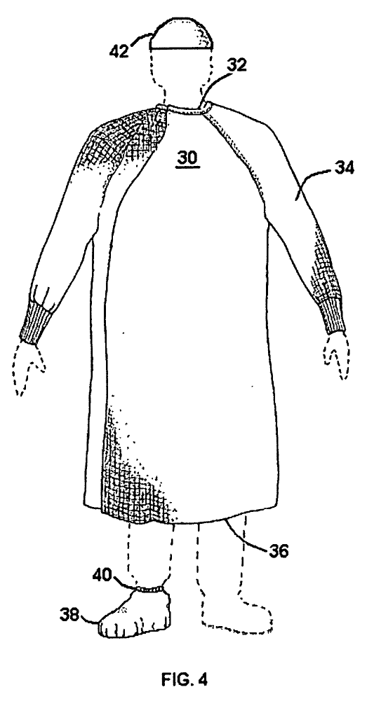

The liquid repellent nonwoven laminate of the invention is highly suitable for various uses, for example, uses including disposable protective articles such as protective fabrics, fabrics for medical products such as patient gowns, sterilization wraps and surgical drapes, gowns, head and shoe coverings, and fabrics for other protective garments. Exemplary medical products are shown schematically in FIG. 4 on a human outline represented by dashed lines. As illustrated in FIG. 4, gown 30 is a loose fitting garment including neck opening 32, sleeves 34, and bottom opening 36. Gown 30 may be fabricated using the nonwoven protective materials of the invention. Also shown on the human outline in FIG. 4 is shoe covering 38 having opening 40 which allows the cover to fit over the foot and/or shoe of a wearer. Shoe covering 38 may be fabricated using the nonwoven protective materials of the invention. Additionally shown in FIG. 4 is head covering 42, such as a surgical cap, which may be fabricated using the nonwoven protective materials of the invention.

While various patents have been incorporated herein by reference, to the extent there is any inconsistency between incorporated material and that of this written specification, the written specification shall control. In addition, while the invention has been described in detail with respect to specific embodiments thereof, it will be apparent to those skilled in the art that various alterations, modifications and other changes may be made to the invention without departing from the spirit and scope of the present invention. It is therefore intended that the claims cover all such modifications, alterations and other changes encompassed by the appended claims.

We claim:

1. A nonwoven laminate material comprising at least one meltspun microfiber layer having an average microfiber diameter of less than about 10 microns and at least one additional nonwoven web layer bonded thereto, wherein said meltspun microfiber layer comprises:
a. a substantially prodegradant-free, non-chemically degraded olefin polymer having a melt flow rate of at least 1500 grams per 10 minutes;
b. a liquid repellency internal additive; and
c. a melt flow modifying agent.

2. The nonwoven laminate material of claim 1 wherein said olefin polymer is present in an amount of from about 78 percent by weight to about 94.9 percent by weight, said liquid repellency internal additive is present in an amount of from about 0.1 percent by weight to about 2 percent by weight, and said melt flow modifying agent is present in an amount of from about 5 percent by weight to about 20 percent by weight, said amounts being based on the total weight of the meltspun microfiber layer.

3. The nonwoven laminate material of claim 2 having one additional nonwoven web layer bonded to each side of said at least one meltspun microfiber layer.

4. The nonwoven laminate material of claim 3 wherein said additional nonwoven web layers are bonded to the meltspun microfiber layer by thermal point bonding, adhesive bonding, or ultrasonic bonding.

5. The nonwoven laminate material of claim 2 wherein said meltspun microfiber layer has an average microfiber diameter of less than about 7 microns.

6. The nonwoven laminate material of claim 5 wherein said meltspun microfiber layer has an average microfiber diameter of less than about 5 microns.

7. The nonwoven laminate material of claim 3 wherein said additional nonwoven web layers are spunbond webs.

8. The nonwoven laminate material of claim 3 wherein at least one of said additional nonwoven web layers comprises from about 0.1 weight percent by weight to about 2 percent by weight of a liquid repellency internal additive, based upon the weight of said at least one additional nonwoven web layers.

9. The nonwoven laminate material of claim 8 wherein at least one of said additional nonwoven web layers is treated with an antistatic treatment.

10. The nonwoven laminate material of claim 7 wherein said spunbond webs are bicomponent spunbond webs.

11. The nonwoven laminate material of claim 3 wherein said liquid repellency internal additive is a fluorocarbon compound present in a range of from about 0.25 percent by weight to about 1.0 percent by weight.

12. The nonwoven laminate material of claim 3 wherein said melt flow modifying agent is an ethylene copolymer of 1-butene.

13. The nonwoven laminate material of claim 2 wherein said olefin polymer is a propylene polymer.

14. The nonwoven laminate material of claim 1 used in a medical product.

15. The nonwoven laminate material of claim 2 used in a medical product.

16. The nonwoven laminate material of claim 3 used in a medical product.

17. The nonwoven laminate material of claim 9 used in a medical product.

18. The nonwoven laminate material of claim 3 used in a protective garment.

19. A process for making a nonwoven laminate material comprising at least one meltspun microfiber layer and at least one additional nonwoven web layer bonded thereto, said method comprising the steps of:
a. providing to a melt spinning apparatus a substantially prodegradant-free olefin polymer having a melt flow rate of at least 1500 grams per 10 minutes, a liquid repellency internal additive and a melt flow modifying agent;
b. extruding from said melt spinning apparatus a mixture of said olefin polymer, liquid repellency internal additive and melt flow modifying agent to form a meltspun microfiber web;
c. providing at least one additional nonwoven web layer; and
d. bonding to said meltspun microfiber web said least one additional nonwoven web layer;
wherein said meltspun microfibers have an average microfiber diameter of less than about 10 microns.

20. The process of claim 19 wherein said olefin polymer is present in an amount of from about 78 percent by weight to about 94.9 percent by weight, said liquid repellency internal additive is present in an amount of from about 0.1 percent by weight to about 2 percent by weight, and said melt flow modifying agent is present in an amount of from about 5 percent by weight to about 20 percent by weight, said amounts being based on the total weight of the meltspun microfiber layer.

21. The process of claim 20 wherein said olefin polymer is a propylene polymer, said liquid repellency internal additive is a fluorocarbon compound, and said melt flow modifying agent is an ethylene copolymer of 1-butene having about 5 percent by weight of ethylene.

22. The process of claim 21 wherein said fluorocarbon compound is present in an amount from about 0.25 percent by weight to about 1.0 percent by weight.
